(19) United States
(12) Patent Application Publication
(10) Pub. No.: US 2025/0298343 A1
(43) Pub. Date: Sep. 25, 2025

(54) DEVELOPING DEVICE AND IMAGE FORMING APPARATUS

(71) Applicant: FUJIFILM Business Innovation Corp., Tokyo (JP)

(72) Inventors: Shota IGAWA, Kanagawa (JP); Kento NATORI, Kanagawa (JP); Masanori KATO, Kanagawa (JP); Yoshihisa NAKAO, Kanagawa (JP); Kiyohito HORII, Kanagawa (JP); Mitsutoshi HONGO, Kanagawa (JP)

(73) Assignee: FUJIFILM Business Innovation Corp., Tokyo (JP)

(21) Appl. No.: 18/818,647

(22) Filed: Aug. 29, 2024

(30) Foreign Application Priority Data
Mar. 22, 2024 (JP) 2024-045884

(51) Int. Cl. G03G 15/095; G03G 15/01; G03G 15/08; G03G 21/20

(52) U.S. Cl. CPC G03G 15/095; G03G 15/0121; G03G 15/0189; G03G 15/0849; G03G 15/0865; G03G 15/0889; G03G 15/0891; G03G 21/206

(57) ABSTRACT

A developing device includes: a supply and transportation unit that transports a developer containing toner and a carrier to a developer holder while supplying the developer to the developer holder, the developer holder holding the developer; an agitation and transportation unit that transports the developer while agitating the developer in a hollow transport path that is disposed to be adjacent to and below the supply and transportation unit in a vertical direction; an upward transport path that is disposed on a downstream side in a transport direction of the agitation and transportation unit and through which the developer transported from the agitation and transportation unit is sent to the supply and transportation unit on an upper side; an air flow path that is provided to be adjacent to and below the transport path in the vertical direction and through which air that is taken in through an inflow port along the transport direction of the agitation and transportation unit flows toward a discharge port; and a detection unit that detects a concentration of the toner in the developer at a position upstream of the upward transport path in the transport direction of the agitation and transportation unit, the detection unit being disposed in the air flow path.

### CROSS-REFERENCE TO RELATED APPLICATIONS

This application is based on and claims priority under 35 USC 119 from Japanese Patent Application No. 2024-045884 filed Mar. 22, 2024.

### BACKGROUND

### (i) Technical Field

The present invention relates to a developing device and an image forming apparatus.

### (ii) Related Art

There is known a powder transport device including a first agitation and transportation unit that agitates and transports a powder, a receiving unit that receives the powder from the first agitation and transportation unit, a second agitation and transportation unit that is disposed below the first agitation and transportation unit in a vertical direction and that agitates and transports a powder, an upward transportation unit that is disposed downstream of the second agitation and transportation unit in a transport direction and that transports the powder transported from the second agitation and transportation unit to the first agitation and transportation unit on an upper side, and a speed increasing unit that increases the speed of rotation of a rotary shaft of any of the first agitation and transportation unit, the second agitation and transportation unit, or the receiving unit and that transmits the rotation to the upward transportation unit (JP2023-88153A).

There is also known a developing device including a housing in which a hollow transport path is formed, a transport member that transports a developer in the transport path, a support portion that is fixed to an end portion of the housing by a fastening member to support the transport member at an end portion of the transport path, and a cooling unit that is fixed by being sandwiched between the support portion and the housing (JP2022-178646A).

### SUMMARY

Aspects of non-limiting embodiments of the present disclosure relate to a developing device and an image forming apparatus that suppress erroneous detection of the concentration of toner in a developer regarding a developing device in which an admix auger and a supply auger are disposed to be vertically adjacent to each other in a gravity direction, while achieving space saving in the developing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device including: a supply and transportation unit that transports a developer containing toner and a carrier to a developer holder while supplying the developer to the developer holder, the developer holder holding the developer; an agitation and transportation unit that transports the developer while agitating the developer in a hollow transport path that is disposed to be adjacent to and below the supply and transportation unit in a vertical direction; an upward transport path that is disposed on a downstream side in a transport direction of the agitation and transportation unit and through which the developer transported from the agitation and transportation unit is sent to the supply and transportation unit on an upper side; an air flow path that is provided to be adjacent to and below the transport path in the vertical direction and through which air that is taken in through an inflow port along the transport direction of the agitation and transportation unit flows toward a discharge port; and a detection unit that detects a concentration of the toner in the developer at a position upstream of the upward transport path in the transport direction of the agitation and transportation unit, the detection unit being disposed in the air flow path.

### BRIEF DESCRIPTION OF THE DRAWINGS

Exemplary embodiment(s) of the present invention will be described in detail based on the following figures, wherein:

FIG. 1 is a schematic cross-sectional view showing an example of a schematic configuration of an image forming apparatus;

FIG. 2 is a schematic vertical cross-sectional view showing a photoreceptor unit and a developing device;

FIG. 3 is a vertical cross-sectional schematic view showing a configuration of the developing device;

FIG. 4 is a schematic cross-sectional view developed in a horizontal direction along line A-B-C and is for description about developer transportation in the developing device;

FIGS. 5A and 5B are views for description about toner concentration detection that is performed by an ATC sensor;

FIGS. 6A and 6B are views for description about removal of a developer from a detection surface of the ATC sensor;

FIG. 7 is a schematic cross-sectional view showing a position at which the ATC sensor is disposed in a modification example;

FIGS. 8A and 8B are views showing a configuration of an air flow path in the developing device; and

FIG. 9 is a schematic cross-sectional view showing the way in which air flows in the air flow path.

### DETAILED DESCRIPTION

Next, the present invention will be more specifically described with reference to the drawings while using exemplary embodiments and a specific example as follows. However, the present invention is not limited to the exemplary embodiments and the specific example.

In addition, note that, in the following description made by using the drawings, the drawings are schematic, the ratio between dimensions or the like is different from the actual ratio, and members other than members that need to be illustrated for description have been appropriately omitted for the sake of easy understanding.

### (1) Overall Configuration and Operation of Image Forming Apparatus

### (1.1) Overall Configuration of Image Forming Apparatus

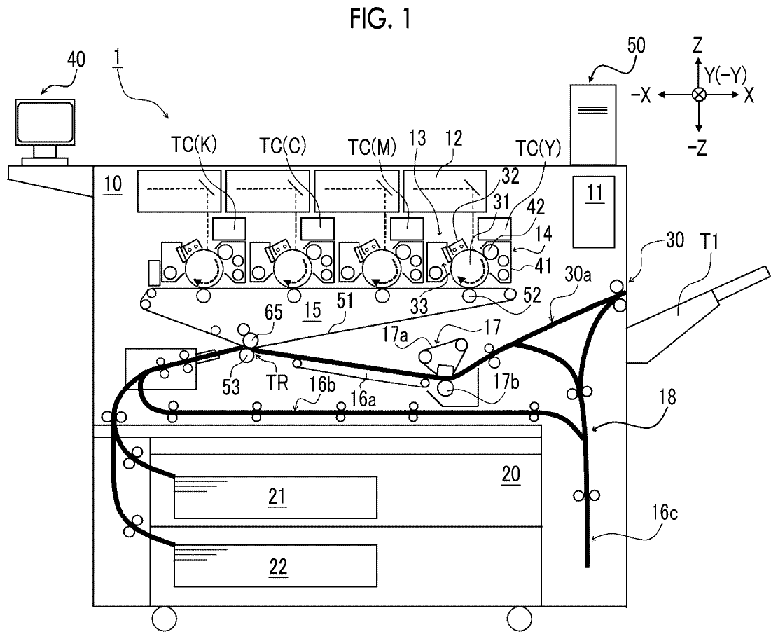

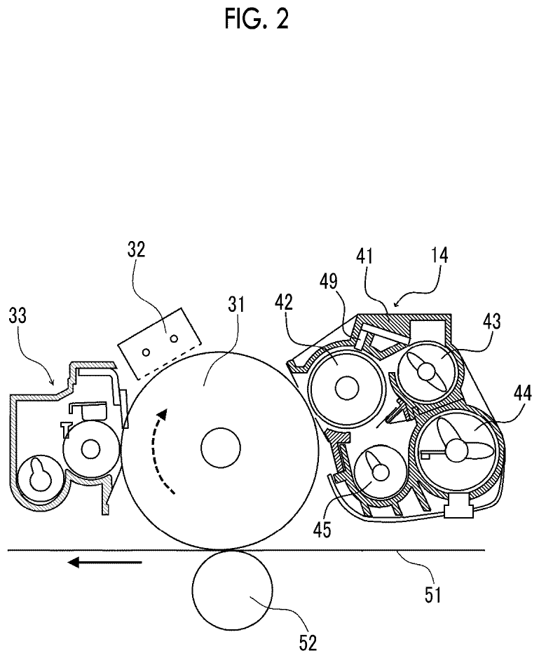

FIG. 1 is a schematic cross-sectional view showing an example of a schematic configuration of an image forming apparatus 1 according to the present exemplary embodiment, and FIG. 2 is a schematic vertical cross-sectional view showing a photoreceptor unit 13 and a developing device 14.

The image forming apparatus 1 is configured to include an image forming section 10, a paper feeding device 20 mounted below the image forming section 10, a paper discharge unit 30 that is provided at one end of the image forming section 10 and that discharges a paper sheet on which printing has been performed, an operation and display unit 40, and an image processing unit 50 that generates image information based on printing information transmitted from an upper-level device.

The image forming section 10 is configured to include a system control device 11, exposure devices 12, photoreceptor units 13, developing devices 14, a transfer device 15, paper transport devices 16a, 16b, and 16c, and a fixing device 17, and in the image forming section 10, a toner image is formed on a recording medium sent from the paper feeding device 20.

The paper feeding device 20 supplies a recording medium to the image forming section 10. That is, the paper feeding device 20 includes a plurality of paper loading portions 21 and 22 that accommodate different types (in material, thickness, paper size, paper grain, for example) of recording mediums, and the paper feeding device 20 supplies, to the image forming section 10, a recording medium fed from any one of the paper loading portion 21 or the paper loading portion 22.

The paper discharge unit 30 discharges a recording medium on which a toner image has been formed in the image forming section 10 and on which the toner image has been fixed in the fixing device 17. Therefore, the paper discharge unit 30 includes a transport path 30a for transportation of the recording medium after the fixation and a discharged-paper accommodation portion T1 for accommodation of the discharged recording medium. In addition, the paper discharge unit 30 includes a paper inverting unit 18 that sends a recording medium to the paper transport device 16b after inverting the recording medium upside down in a case where toner images are to be formed on both surfaces of the recording medium. Note that the paper discharge unit 30 may have a function of performing post-processing such as cutting or stapling on a paper bundle output from the image forming section 10.

The operation and display unit 40 is used for various settings, to input instructions, and to display information. That is, the operation and display unit 40 corresponds to a so-called user interface and is configured by combining a liquid crystal display panel, various operation buttons, a touch panel, and the like with each other.

The image processing unit 50 is configured as, for example, a dedicated processor or a processing board and executes image processing such as color correction and gradation correction. Data processed by the image processing unit 50 is sent to the image forming section 10.

### (1.2) Configuration and Operation of Image Forming Section

In the image forming apparatus 1 having such a configuration, a recording medium fed from designated paper loading portions 21 and 22 out of the paper loading portions 21 and 22 is sent to the image forming section 10 in accordance with the timing of image formation each time printing is performed on one sheet in a printing job.

The image forming section 10 includes the photoreceptor units 13 and the developing devices 14.

The photoreceptor units 13 are respectively provided below the exposure devices 12 in parallel with each other and each of the photoreceptor units 13 includes a photoreceptor drum 31 as an image holding body that is rotationally driven. A charger 32, the exposure device 12, the developing device 14, a primary transfer roller 52, and a cleaning device 33 are disposed along a rotation direction (represented by an arrow in drawings) of the photoreceptor drum 31.

In each developing device 14, a development roller 42 serving as a developer holder is disposed to face the photoreceptor drum 31. The developing devices 14 are configured in the approximately same manner as each other except a developer, and respectively form yellow (Y), magenta (M), cyan (C), and black (K) toner images on the photoreceptor drums 31 that the respective development rollers 42 of the developing devices 14 face.

Above the developing devices 14, interchangeable toner cartridges TC that accommodate toner and toner supply devices (not shown) that supply toner and carriers to the developing devices 14 from the toner cartridges TC, respectively, are disposed.

Surfaces of the photoreceptor drums 31 rotating are uniformly charged by the chargers 32, and electrostatic latent images are formed on the surfaces by electrostatic latent image forming light emitted from the exposure devices 12. The electrostatic latent images formed on the photoreceptor drums 31 are developed as toner images by the development rollers 42.

The transfer device 15 is configured to include an intermediate transfer belt 51, onto which color toner images respectively formed on the photoreceptor drums 31 of the photoreceptor units 13 are multilayer-transferred, the primary transfer rollers 52 that sequentially transfer (primary transfer) the color toner images respectively formed on the photoreceptor units 13 to the intermediate transfer belt 51, and a secondary transfer roller 53 that collectively transfers (secondary transfer), to a recording medium, the color toner images superimposed and transferred onto the intermediate transfer belt 51.

The color toner images respectively formed on the photoreceptor drums 31 of the photoreceptor units 13 are sequentially electrostatically transferred (primary transfer) onto the intermediate transfer belt 51 by the primary transfer rollers 52 to which a predetermined transfer voltage is applied from a power supply device or the like (not shown) controlled by the system control device 11, so that a superimposition toner image formed by superimposed color toner is formed.

As the intermediate transfer belt 51 moves, the superimposition toner image on the intermediate transfer belt 51 is transported to a secondary transfer portion TR where the secondary transfer roller 53 is disposed to come into pressure-contact with a backup roller 65 with the intermediate transfer belt 51 interposed therebetween.

In a case where the superimposition toner image is transported to the secondary transfer portion TR, a recording medium is supplied to the secondary transfer portion TR from the paper feeding device 20 in accordance with the timing of the transportation. Then, a predetermined secondary transfer voltage from a power supply device (not shown) controlled by the system control device 11 is applied to the backup roller 65 that faces the secondary transfer roller 53 with the intermediate transfer belt 51 interposed therebetween so that the superimposition toner image on the intermediate transfer belt 51 is collectively transferred onto the recording medium.

Residual toner on a surface of the photoreceptor drum 31 is removed by the cleaning device 33 and is collected into a waste toner accommodation portion (not shown). Then, the surface of the photoreceptor drum 31 is uniformly recharged by the charger 32, and the next image formation cycle is started.

The fixing device 17 includes an endless fixation belt 17a that rotates in one direction and a pressing roller 17b that is in contact with a peripheral surface of the fixation belt 17a and that rotates in one direction, and a nip portion (a fixation region) is formed in a pressure-contact region between the fixation belt 17a and the pressing roller 17b.

A recording medium on which toner images have been transferred in the transfer device 15 is transported to the fixing device 17 via the paper transport device 16a in a state where the toner images are not fixed. Onto the recording medium transported to the fixing device 17, the toner images are fixed through heating and pressing performed by means of the fixation belt 17a and the pressing roller 17b which form a pair.

The recording medium subjected to the fixation is sent to the paper discharge unit 30 and is loaded on the discharged-paper accommodation portion T1. In addition, post-processing such as cutting or stapling is performed as necessary.

### (2) Developing Device

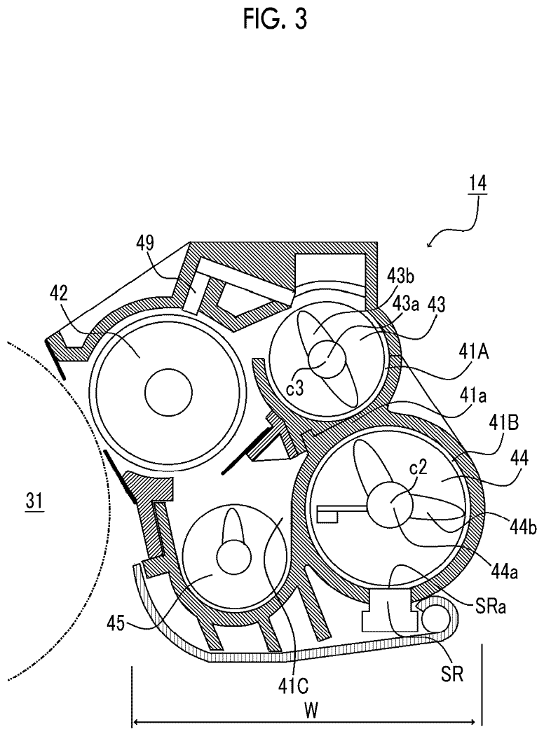

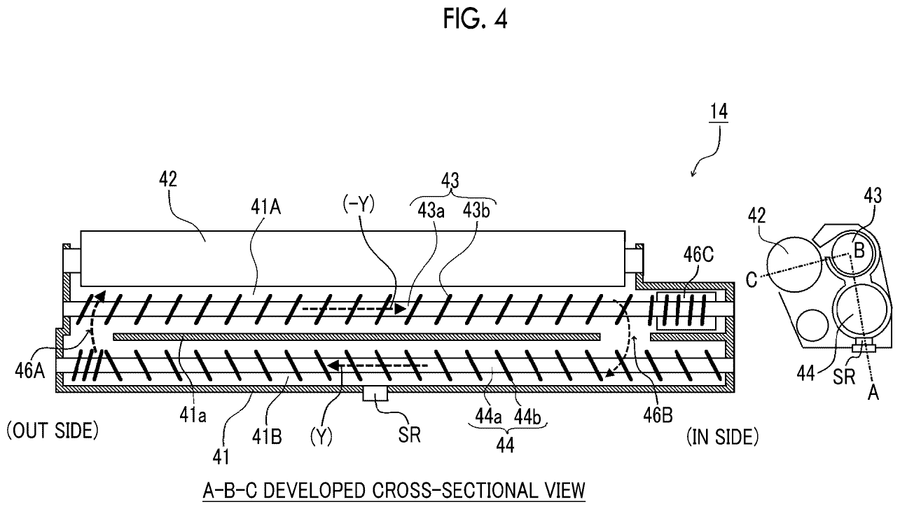

FIG. 3 is a vertical cross-sectional schematic view showing a configuration of the developing device 14, and FIG. 4 is a schematic cross-sectional view developed in a horizontal direction along line A-B-C and is for description about developer transportation in the developing device 14.

Hereinafter, the configuration and the operation of the developing device 14 will be described with reference to the drawings.

### (2.1) Overall Configuration of Developing Device

The developing device 14 includes a development housing 41 that accommodates a developer containing toner and a carrier, the development roller 42 which is an example of a developer holder that holds the developer and that transports the developer to a development region facing the photoreceptor drum 31, a supply auger 43 which is an example of a supply and transportation unit that transports the developer to pass through the development roller 42 and to be supplied while agitating the developer, an admix auger 44 which is an example of an agitation and transportation unit that transports the developer to the supply auger 43 while agitating the developer, a counter auger 45 that transports the developer separated from the development roller 42 in a direction opposite to a transport direction of the admix auger 44, a layer thickness restriction member 49 that restricts the amount of the developer (a layer thickness) held by the development roller 42, and the like.

The development roller 42 includes a magnet therein, and is rotated in a state where the developer sticks onto a surface of the development roller 42 due to a magnetic force so that the developer is transported from the development housing 41 to a development position facing the photoreceptor drum 31. At the development position, development of an electrostatic latent image formed on the photoreceptor drum 31 is performed and the developer after the development returns to the inside of the development housing 41 due to rotation of the development roller 42.

### (2.2) Circulation of Developer

FIG. 4 is a schematic cross-sectional view developed in the horizontal direction along the line A-B-C in a vertical schematic cross-sectional view and is for description about developer transportation (movement) in the developing device 14.

As shown in FIG. 3, for accommodation of the supply auger 43 and the admix auger 44, a first developer accommodation portion 41A and a second developer accommodation portion 41B, each of which is formed to have a cross-section that is approximately cylindrical, are provided in the development housing 41.

The second developer accommodation portion 41B is partitioned by a partition wall 41a provided in the development housing 41 and is disposed to be adjacent to and below the first developer accommodation portion 41A in a vertical direction. In addition, the development housing 41 is provided with a third developer accommodation portion 41C for accommodation of the counter auger 45 and the developer separated from the development roller 42 and transportation of the developer in the direction opposite to the transport direction of the admix auger 44. In addition, as schematically shown in FIG. 4, at both end portions of the partition wall 41a in a longitudinal direction, openings 46A and 46B, through which the developer is delivered between the supply auger 43 and the admix auger 44 disposed to be adjacent to each other in the vertical direction, are respectively provided.

Regarding the supply auger 43 and the admix auger 44, spiral blades 43b and 44b are formed around rotary shafts 43a and 44a and the supply auger 43 and the admix auger 44 rotate along inner walls of the first developer accommodation portion 41A and the second developer accommodation portion 41B with rotational driving forces received from a drive source (not shown) so that the developer is transported in a predetermined direction in the first developer accommodation portion 41A and the second developer accommodation portion 41B.

Specifically, the admix auger 44 transports the developer in the second developer accommodation portion 41B in a direction along an arrow (Y) while agitating the developer, and the supply auger 43 transports the developer in the first developer accommodation portion 41A in a direction along an arrow (−Y) while agitating the developer. The developer transported in the direction along the arrow (Y) is moved (pumped up) to the first developer accommodation portion 41A through the opening 46A which is an example of an upward transport path, and the developer transported in the direction along the arrow (−Y) is moved (falls) to the second developer accommodation portion 41B through the opening 46B.

Accordingly, the developer in the development housing 41 is circulated and moved while being agitated by the admix auger 44 and the supply auger 43. Then, the toner in the developer is charged with the developer agitated in such a manner.

An upper surface portion of an IN side (a −Y direction, a device rear side) of the development housing 41 is provided with an inlet port 46C (in FIG. 4, schematically shown for description of functions) through which toner and a carrier supplied from the toner cartridge TC enter the development housing 41. The toner that enters the developing device 14 through the inlet port 46C is moved to the second developer accommodation portion 41B of the development housing 41 by being transported by the supply auger 43 and is mixed with the developer.

The toner supplied from the toner cartridge TC through the inlet port 46C is transported from the IN side to an OUT side (a Y direction: a device front surface side) while being agitated by the admix auger 44 together with the carrier, and is moved to the first developer accommodation portion 41A, in which the supply auger 43 is disposed, through the opening 46A on the OUT side. Then, the toner is supplied to the development roller 42 together with the carrier while being transported to the IN side by the supply auger 43.

### (2.3) Toner Concentration Detection

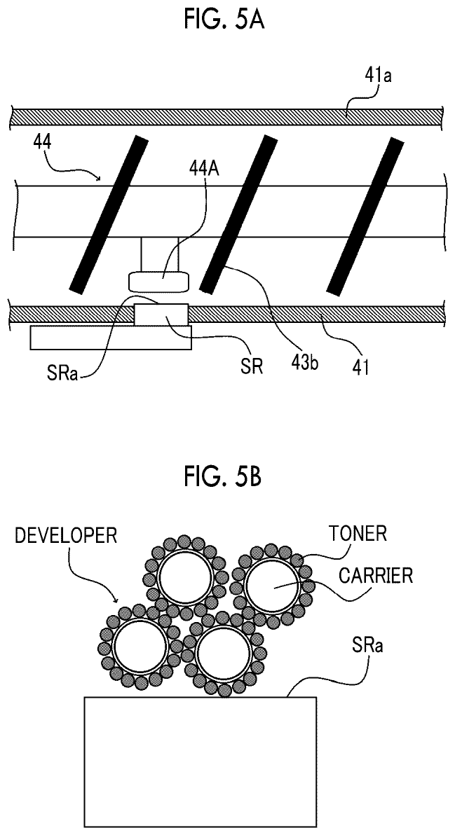

FIGS. 5A and 5B are views for description about toner concentration detection that is performed by an ATC sensor.

In the developing device 14, an auto toner control (ATC) sensor SR, which is an example of a detection unit that measures a ratio (a toner concentration: TC) of toner to a carrier in a developer circulating in the development housing 41, is disposed.

As shown in FIGS. 5A and 5B, the ATC sensor SR measures, through a detection surface SRa coming into contact with the developer, a change in magnetic permeability that depends on a toner concentration (TC) in the developer and for example, the ATC sensor SR detects the toner concentration (TC) by detecting a change in analog output voltage. In the image forming apparatus 1, the system control device 11 issues, based on a value measured by the ATC sensor SR, an instruction to supply toner from the toner cartridge TC so that a TC value of the developer is maintained at a predetermined value.

The toner supplied from the toner cartridge TC is mixed with a carrier and transported from the IN side to the OUT side in the second developer accommodation portion 41B while being agitated by the admix auger 44. It is desirable that the toner concentration in the developer is detected at, for example, a position on the OUT side (a pump-up position at which the developer is pumped up to the supply auger 43 through the opening 46A) at which the toner has been sufficiently agitated. However, at the pump-up position, the amount and the density of the developer in a detection range of the ATC sensor SR are not stable, and thus there may be a change in output of the ATC sensor SR.

In the present exemplary embodiment, as shown in FIG. 4, the ATC sensor SR is disposed upstream of the pump-up position in a direction in which the developer is transported by the admix auger 44.

More specifically, the ATC sensor SR is disposed at an approximately central portion of the second developer accommodation portion 41B in the direction in which the developer is transported by the admix auger 44. At the approximately central portion of the second developer accommodation portion 41B, the amount and the density of the developer are stable in comparison with the pump-up position and thus the accuracy of toner concentration detection performed by the ATC sensor SR is improved.

In addition, as shown in FIG. 3, in a rotation direction of the admix auger 44, the ATC sensor SR is disposed below a rotary center c2 of the admix auger 44 in the vertical direction. Accordingly, it is possible to achieve space saving in the developing device 14 (represented by W in FIG. 3).

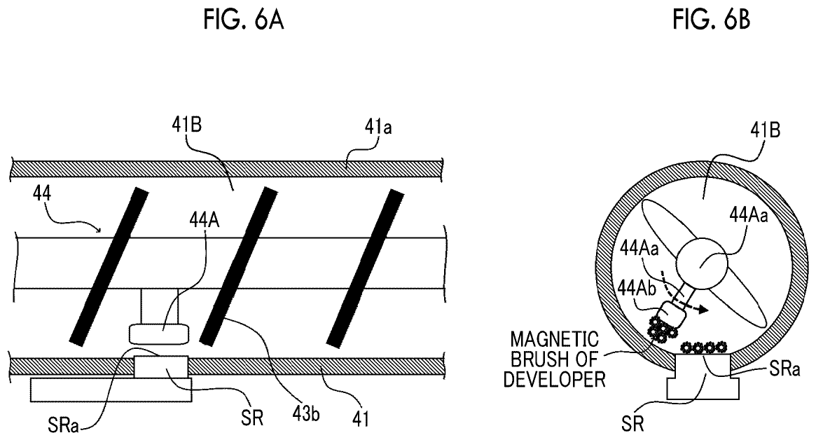

In the present exemplary embodiment, as shown in FIG. 3 (refer to FIG. 6B also), the second developer accommodation portion 41B has a circular cross-sectional shape in a direction intersecting a developer transport direction and a space, in which toner that is mixed with a carrier by being agitated by the admix auger 44 floats from a developer surface and is transported, is substantially not formed above the admix auger 44, which is rotatably accommodated in the second developer accommodation portion 41B, in the vertical direction. Accordingly, the toner being agitated in a state of floating above the developer surface may be suppressed and toner concentration may be stably detected even in a case where the ATC sensor SR is disposed at the approximately central portion of the second developer accommodation portion 41B in the developer transport direction.

FIGS. 6A and 6B are views for description about removal of the developer from the detection surface SRa of the ATC sensor SR.

The admix auger 44 is provided with a magnetic paddle 44A, which is an example of a removal unit that comes into contact with the detection surface SRa of the ATC sensor SR across an area from one end to the other end of the detection surface SRa and that removes a developer remaining on the detection surface SRa, the magnetic paddle 44A being provided at a position facing the ATC sensor SR.

The magnetic paddle 44A consists of an arm portion 44Aa that protrudes in a radial direction from a rotary shaft 44a of the admix auger 44 and a magnet 44Ab that is provided at a distal end of the arm portion 44Aa, and the magnetic paddle 44A is rotatable around the rotary shaft 44a integrally with the admix auger 44.

In a case where the magnetic paddle 44A is rotated, a magnetic brush of the developer sticking to the magnet 44Ab comes into contact with the detection surface SRa of the ATC sensor SR and removes a developer on the detection surface SRa. Accordingly, it is possible to restrain the developer from remaining on the detection surface SRa and to improve the detection accuracy of the toner concentration.

### Modification Example

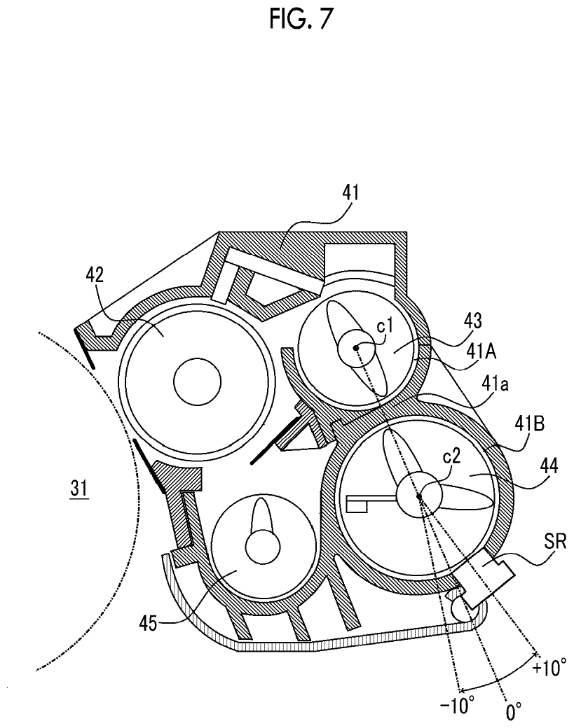

FIG. 7 is a schematic cross-sectional view showing a position at which the ATC sensor SR is disposed in a modification example.

The ATC sensor SR may be disposed within a range of +10 degrees to −10 degrees on an assumption that a straight line that connects a rotary center c1 of the supply auger 43 and the rotary center c2 of the admix auger 44 is at an angle of 0 degrees. In comparison with a case where the ATC sensor SR is disposed below the rotary center c2 of the admix auger 44 in the vertical direction, a developer that is agitated is likely to be compressed and thus it is possible to improve the accuracy of toner concentration detection while achieving space saving in the developing device.

### (2.4) Air Flow Path

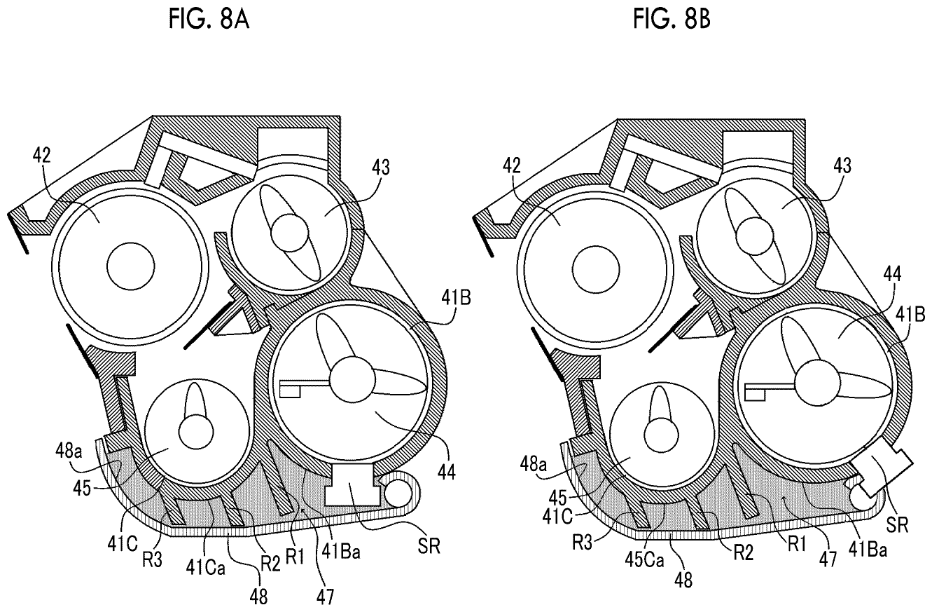

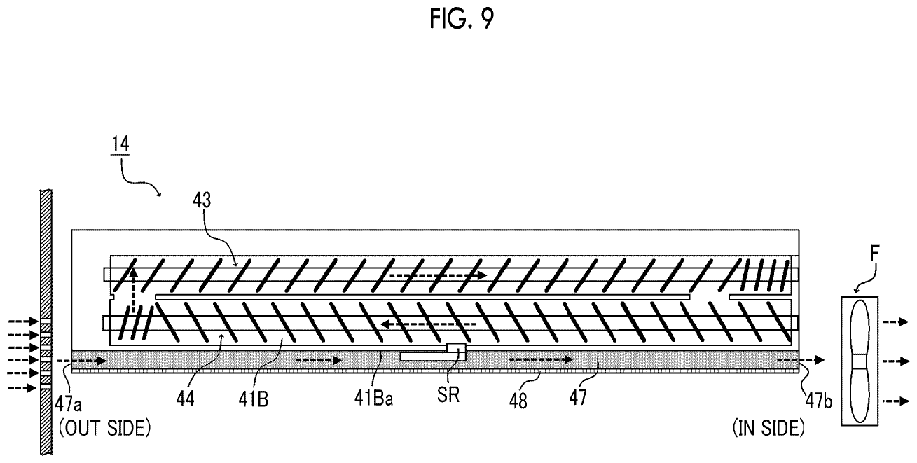

FIGS. 8A and 8B are views showing a configuration of an air flow path 47 in the developing device 14, and FIG. 9 is a schematic cross-sectional view showing the way in which air flows in the air flow path 47.

In the developing device 14, the air flow path 47 that is adjacent to and below the second developer accommodation portion 41B in the vertical direction and through which air that is taken in through an inflow port along the transport direction of the admix auger 44 flows toward a discharge port is formed.

The air flow path 47 is configured by using a portion of an outer surface 41Ba of the second developer accommodation portion 41B that accommodates the admix auger 44. Specifically, as shown in FIGS. 8A and 8B, the air flow path 47 is composed of a gap (represented by dot points in the drawing) between the outer surface 41Ba of the second developer accommodation portion 41B, an outer surface 41Ca of the third developer accommodation portion 41C, and a plate-shaped body 48 that is provided to face the outer surface 41Ba of the second developer accommodation portion 41B and the outer surface 41Ca of the third developer accommodation portion 41C.

A plurality of ribs R1, R2, and R3 are provided to be continuously erected in a longitudinal direction of the developing device 14 on the outer surface 41Ba of the second developer accommodation portion 41B that accommodates the admix auger 44 and on the outer surface 41Ca of the third developer accommodation portion 41C that accommodates the counter auger 45 and that is for transportation of the developer in a direction opposite to the transport direction of the admix auger 44. The plate-shaped body 48 is provided in the longitudinal direction of the developing device 14 to face the plurality of ribs R1, R2, and R3 and the air flow path 47 that communicates with the OUT side (the inflow port) and the IN side (the discharge port) of the developing device 14 in the longitudinal direction of the developing device 14 is formed between an inner surface 48a of the plate-shaped body 48, the outer surface 41Ba of the second developer accommodation portion 41B, and the outer surface 41Ca of the third developer accommodation portion 41C.

In the developing device 14 of the present exemplary embodiment, the developer is transported from the IN side (the device rear side) to the OUT side (the device front surface side) by the admix auger 44 and is moved to the first developer accommodation portion 41A, in which the supply auger 43 is disposed, at a position on the OUT side, which is the pump-up position. Accordingly, in the developing device 14, the developer that circulates is likely to be compressed on the OUT side, and the temperature of the developer on the OUT side is likely to be made higher than the temperature of the developer in other places.

In the present exemplary embodiment, as schematically shown in FIG. 9, an opening is formed in a louver shape on a front surface side (the OUT side) of the image forming apparatus 1, and an intake fan F is disposed on a rear side (the IN side) of the image forming apparatus 1. In the developing device 14 mounted to such an image forming apparatus 1, the outside air flowing in through an inflow port 47a on the OUT side of the air flow path 47 flows inside the air flow path 47 and is discharged from through a discharge port 47b on the IN side. Accordingly, it is possible to prevent the ATC sensor SR from erroneously detecting the concentration of toner due to the air flow path 47 clogged with the developer while achieving space saving in the developing device 14.

### (3) Action of Developing Device

The developing device 14 includes: the supply auger 43 that transports a developer containing toner and a carrier to the development roller 42 while supplying the developer to the development roller 42, the development roller 42 holding the developer; the admix auger 44 that transports the developer while agitating the developer in a hollow transport path that is disposed to be adjacent to and below the supply auger 43 in the vertical direction; the opening 46A serving as an upward transport path that is disposed on a downstream side in the transport direction of the admix auger 44 and through which the developer transported from the admix auger 44 is sent to the supply auger 43 on an upper side; and the ATC sensor SR that detects the concentration of toner in the developer at a position upstream of the opening 46A in the transport direction of the admix auger 44. The ATC sensor SR is disposed at the approximately central portion of the second developer accommodation portion 41B for accommodation of the admix auger 44, which is on the upstream side in the transport direction of the admix auger 44, so that the amount and the density of the developer are made stable in comparison with the upward transport path and thus the accuracy of toner concentration detection is improved.

In the second developer accommodation portion 41B, the second developer accommodation portion 41B has a circular cross-sectional shape in a direction intersecting the developer transport direction and a space, in which toner that is mixed with a carrier by being agitated by the admix auger 44 floats from the developer surface and is transported, is substantially not formed above the admix auger 44, which is rotatably accommodated in the second developer accommodation portion 41B, in the vertical direction. Accordingly, toner may be restrained from being agitated in a state of floating above the developer surface.

The ATC sensor SR is disposed below the rotary center c2 of the admix auger 44 in the vertical direction. Accordingly, it is possible to achieve space saving in the developing device 14.

The ATC sensor SR may be disposed within a range of +10 degrees to −10 degrees on an assumption that a straight line that connects the rotary center c1 of the supply auger 43 and the rotary center c2 of the admix auger 44 is at an angle of 0 degrees. Accordingly, it is possible to further improve the accuracy of toner concentration detection while achieving space saving in the developing device 14.

The magnetic paddle 44A that comes into contact with the detection surface SRa of the ATC sensor SR across an area from one end to the other end of the detection surface SRa and that removes a developer remaining on the detection surface SRa is provided, the detection surface SRa being exposed in the second developer accommodation portion 41B. The magnetic paddle 44A consists of the arm portion 44Aa that protrudes in the radial direction from the rotary shaft 44a of the admix auger 44 and the magnet 44Ab that is provided at the distal end of the arm portion 44Aa, and a magnetic brush of the developer sticking to the magnet 44Ab comes into contact with the detection surface SRa of the ATC sensor SR and removes the developer remaining on the detection surface SRa. Accordingly, detection of the concentration of toner in the developer may be stabilized.

The air flow path 47 that is provided to be adjacent to and below the second developer accommodation portion 41B in the vertical direction and through which air that is taken in through the inflow port along the transport direction of the admix auger 44 flows toward the discharge port is formed. The air flow path 47 is configured by using a portion of the outer surface 41Ba of the second developer accommodation portion 41B and is composed of a gap between the outer surface 41Ba of the second developer accommodation portion 41B and the plate-shaped body 48 provided to face the outer surface 41Ba. Accordingly, it is possible to suppress erroneous detection of the concentration of toner in the developer while achieving space saving in the developing device 14.

### SUPPLEMENTARY NOTE

The present specification discloses at least the following inventions.
[1]

A developing device comprising:
a supply and transportation unit that transports a developer containing toner and a carrier to a developer holder while supplying the developer to the developer holder, the developer holder holding the developer;
an agitation and transportation unit that transports the developer while agitating the developer in a hollow transport path that is disposed to be adjacent to and below the supply and transportation unit in a vertical direction;
an upward transport path that is disposed on a downstream side in a transport direction of the agitation and transportation unit and through which the developer transported from the agitation and transportation unit is sent to the supply and transportation unit on an upper side;
an air flow path that is provided to be adjacent to and below the transport path in the vertical direction and through which air that is taken in through an inflow port along the transport direction of the agitation and transportation unit flows toward a discharge port;
a detection unit that detects a concentration of the toner in the developer at a position upstream of the upward transport path in the transport direction of the agitation and transportation unit, the detection unit being disposed in the air flow path; and
a removal unit that removes the developer remaining on a detection surface of the detection unit with the removal unit coming into contact with the detection surface across an area from one end to the other end of the detection surface, the detection surface being exposed in the transport path.
[2]

The developing device according to [1],
wherein the transport path has a circular cross-sectional shape in a direction intersecting a developer transport direction, and
a space, in which the toner that is mixed with the carrier by being agitated by the agitation and transportation unit floats from a developer surface and is transported, is substantially not formed above the agitation and transportation unit, which is rotatably accommodated in the transport path, in the vertical direction.
[3]

The developing device according to [1] or [2],
wherein the air flow path is composed of a gap between an outer surface of the transport path and a plate-shaped body provided to face the outer surface.
[4]

The developing device according to any one of [1] to [3],
wherein the detection unit is disposed below a rotary center of the agitation and transportation unit in the vertical direction.
[5]

The developing device according to any one of [1] to [3],
wherein the detection unit is disposed within a range of +10 degrees to −10 degrees on an assumption that a straight line that connects a rotary center of the supply and transportation unit and a rotary center of the agitation and transportation unit is at an angle of 0 degrees.
[6]

The developing device according to any one of [1] to [5],
wherein the detection unit detects the concentration of the toner in the developer with a detection surface brought into contact with the developer, the detection surface being exposed in the transport path.
[7]

The developing device according to any one of [1] to [6],
wherein the removal unit is a magnetic brush of the developer sticking to a magnetic material integrally provided with the agitation and transportation unit.
[8]

An image forming apparatus comprising:
an air sending unit;
an image holding body that holds an electrostatic latent image; and
a developing unit that develops the electrostatic latent image of the image holding body,
wherein the developing device according to any one of [1] to [7] is used as the developing unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a supply and transportation unit that transports a developer containing toner and a carrier to a developer holder while supplying the developer to the developer holder, the developer holder holding the developer;
an agitation and transportation unit that transports the developer while agitating the developer in a hollow transport path that is disposed to be adjacent to and below the supply and transportation unit in a vertical direction;
an upward transport path that is disposed on a downstream side in a transport direction of the agitation and transportation unit and through which the developer transported from the agitation and transportation unit is sent to the supply and transportation unit on an upper side;
an air flow path that is provided to be adjacent to and below the transport path in the vertical direction and through which air that is taken in through an inflow port along the transport direction of the agitation and transportation unit flows toward a discharge port; and
a detection unit that detects a concentration of the toner in the developer at a position upstream of the upward transport path in the transport direction of the agitation and transportation unit, the detection unit being disposed in the air flow path.

2. The developing device according to claim 1,
wherein the air flow path is configured by using a portion of an outer surface of the transport path.

3. The developing device according to claim 2,
wherein the air flow path is composed of a gap between the outer surface of the transport path and a plate-shaped body provided to face the outer surface.

4. The developing device according claim 1,
wherein the detection unit is disposed below a rotary center of the agitation and transportation unit in the vertical direction.

5. The developing device according to claim 1,
wherein the detection unit is disposed within a range of +10 degrees to −10 degrees on an assumption that a straight line that connects a rotary center of the supply and transportation unit and a rotary center of the agitation and transportation unit is at an angle of 0 degrees.

6. An image forming apparatus comprising:
an air sending unit;
an image holding body that holds an electrostatic latent image; and
a developing unit that develops the electrostatic latent image of the image holding body,
wherein the developing device according to claim 1 is used as the developing unit.

7. An image forming apparatus comprising:
an air sending unit;
an image holding body that holds an electrostatic latent image; and
a developing unit that develops the electrostatic latent image of the image holding body,
wherein the developing device according to claim 2 is used as the developing unit.

8. An image forming apparatus comprising:
an air sending unit;
an image holding body that holds an electrostatic latent image; and
a developing unit that develops the electrostatic latent image of the image holding body,
wherein the developing device according to claim 3 is used as the developing unit.

9. An image forming apparatus comprising:
an air sending unit;
an image holding body that holds an electrostatic latent image; and
a developing unit that develops the electrostatic latent image of the image holding body,
wherein the developing device according to claim 4 is used as the developing unit.

10. An image forming apparatus comprising:
an air sending unit;
an image holding body that holds an electrostatic latent image; and
a developing unit that develops the electrostatic latent image of the image holding body,
wherein the developing device according to claim 5 is used as the developing unit.

11. A developing device comprising:
supply and transportation means for transporting a developer containing toner and a carrier to a developer holder while supplying the developer to the developer holder, the developer holder holding the developer;
agitation and transportation means for transporting the developer while agitating the developer in a hollow transport path that is disposed to be adjacent to and below the supply and transportation means in a vertical direction;
an upward transport path that is disposed on a downstream side in a transport direction of the agitation and transportation means and through which the developer transported from the agitation and transportation means is sent to the supply and transportation means on an upper side;
an air flow path that is provided to be adjacent to and below the transport path in the vertical direction and through which air that is taken in through an inflow port along the transport direction of the agitation and transportation means flows toward a discharge port; and
detection means for detecting a concentration of the toner in the developer at a position upstream of the upward transport path in the transport direction of the agitation and transportation unit, the detection means being disposed in the air flow path.
